(19) United States
(12) Patent Application Publication
(10) Pub. No.: US 2005/0247129 A1
(43) Pub. Date: Nov. 10, 2005

(54) Disposable measuring cups

(76) Inventor: Diane Carragan, Metairie, LA (US)

Correspondence Address: GALASSO & ASSOCIATES, LP, P.O. Box 26503, Austin, TX, 78755-0503, US

(21) Appl. No.: 11/104,185

(22) Filed: Apr. 12, 2005

Related U.S. Application Data
(60) Provisional application No. 60/561,676, filed on Apr. 13, 2004.

(51) Int. Cl. G01F 19/00

(52) U.S. Cl. 73/426

(57) ABSTRACT

A measuring cup comprises a cup body having a measuring cavity and indicia denoting a volume of at least a portion of the measuring cavity. The cup body is formed from a biodegradable material. The cup body is manually flattenable such that the cup body can be manually flattened to save space during disposal. The biodegradable material is a substantially non-transparent material. The indicia is provided within the measuring cavity.

### CROSS REFERENCE TO RELATED APPLICATIONS

This patent application claims priority to co-pending U.S. Provisional Patent Application having Ser. No. 60/561,676 filed Apr. 13, 2004 entitled “Disposable Measuring Cups”, having a common applicant herewith and being incorporated herein in its entirety by reference.

### FIELD OF THE DISCLOSURE

The disclosures made herein relate generally to measuring volume of liquid and dry goods and, more particularly, to measuring cups configured for measuring volume of liquid and dry goods.

### BACKGROUND

Measuring cups are well known. They are typically made from materials such as, for example, plastic, metal and glass. Typically, measuring cups have indicia marked upon a surface for specifying a particular volume of the cup or volume at a particular degree of fill. In a set of measuring cups, each one of the cups has a different volume (e.g., ¼ cup, ½ cup and 1 cup), which is marked on a surface of the cup. In a multi-volume measuring cup, various volumes are marked on the cup at respective locations.

Conventionally, measuring cups are a utensil whose service life is quite lengthy. A set of measuring cups may be used for years, if not decades. For example, when using measuring cups as a kitchen utensil, they are generally used to measure various cooking items (e.g., cooking oil, flour, baking soda, baking power, sugar, etc) and washed after use. Thus, there is not an essential reason why a set of measuring cups would be disposed of after use.

However, in some instances, cleaning and reusing a conventional measuring cup is not practical and/or desirable. When a measuring cup is used for measuring hazardous and/or toxic materials, it is often not practical to wash and reuse the measuring cup even if the hazardous and/or toxic material can be removed to a point where the measuring cup aesthetically looks clean. This is particularly true in a household setting where the potential exists for the measuring cup to be subsequently used for measuring food items. Quite likely, the measuring cup is contaminated even though it looks clean. In the case where a measuring cup is used for measuring hazardous and/or toxic materials without any intention of it subsequently being used for measuring food items, it is still often desirable to dispose of the measuring cup from a safety standpoint. After use, the measuring cup becomes a health concern, particularly if it is not suitably cleaned or stored in a safe place. Lastly, for some users, cleaning a measuring cup and storing it is less than desirable. From a convenience standpoint, some users of measuring cups would prefer to dispose of a measuring cup after use rather than clean and reuse it, regardless of the particular application.

Therefore, a measuring cup specifically configured and intended for being disposed of after use would be useful and advantageous.

### SUMMARY OF THE DISCLOSURE

Embodiments of measuring cups in accordance with the present invention are specifically configured and intended for being disposed of after use. Unlike conventional measuring cups, measuring cups in accordance with the present invention are specifically configured for use in situations where cleaning and reusing a conventional measuring cup is not practical and/or desirable. Accordingly, measuring cups in accordance with the present invention are useful and advantageous relative to conventional measuring cups in that they are intended for being disposable.

In one embodiment of the present invention, a measuring cup comprises a cup body having a measuring cavity and indicia denoting a volume of at least a portion of the measuring cavity. The cup body is formed from a biodegradable material.

In another embodiment of the present invention, a measuring cup comprises a cup body having a measuring cavity and indicia denoting a volume of at least a portion of the measuring cavity. The cup body is formed from a biodegradable material. The cup body is manually flattenable such that the cup body can be manually flattened to save space during disposal. The biodegradable material is a substantially non-transparent material. The indicia is provided within the measuring cavity.

In another embodiment of the present invention, a set of measuring cups comprises a plurality of different volume measuring cups. Each one of the measuring cups includes a cup body having a measuring cavity and is formed from a biodegradable material. Additionally, each one of the measuring cups includes indicia denoting a volume of the measuring cavity thereof.

Turning now to specific aspects of the present invention, in at least one embodiment, the indicia is provided within the measuring cavity.

In at least one embodiment of the present invention, the material from which the cup body is formed is a non-transparent material such as an opaque material.

In at least one embodiment of the present invention, the cup body is manually flattenable such that the cup body can be flattened to save space during disposal.

In at least one embodiment of the present invention, the cup body includes a handle.

In at least one embodiment of the present invention, the handle is movable between a use position and a stacking position and the cup body is stackable in a nested orientation within an identical other cup body when the handle is in the stacking position.

In at least one embodiment of the present invention, the indicia denote a plurality of different types of volume measurements and the indicia denotes a plurality of different volumes for each one of said different types of volume measurements.

These and other objects, embodiments advantages and/or distinctions of the present invention will become readily apparent upon further review of the following specification and associated drawings.

### BRIEF DESCRIPTION OF THE DRAWINGS

FIG. 1 depicts a first embodiment of a measuring cup in accordance with the present invention.

FIG. 2 is a cross-sectional view taken along the line 2-2 in FIG. 1.

FIG. 3 depicts a second embodiment of a measuring cup in accordance with the present invention.

FIG. 4 depicts a stack of measuring cups in accordance with the present invention.

FIG. 5 depicts a third embodiment of a measuring cup in accordance with the present invention.

### DETAILED DESCRIPTION OF THE DRAWING FIGURES

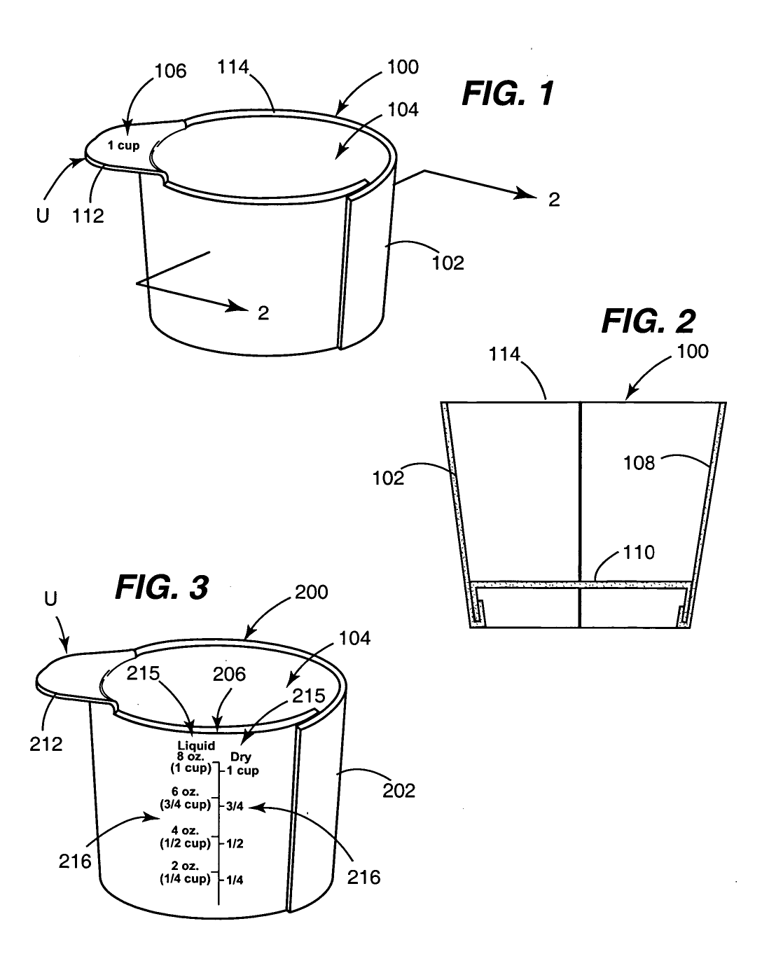

FIGS. 1 and 2 depict a first embodiment of a measuring cup in accordance with the present invention, which is generally referred to as the measuring cup 100. The measuring cup 100 includes a cup body 102 having a measuring cavity 104 and includes indicia 106. The cup body 102 has a side wall 108 and a bottom wall 110. As depicted, a handle 112 is integrally formed with the side wall 108 (e.g., a common piece of material comprises the side wall 108 and the handle 112). In a use position U, the handle 112 provides a means for grasping of the measuring cup 100 for enabling a volume of material to be scooped into the measuring cavity 104. Alternatively, the handle 112 may be formed separately from the side wall 108 and subsequently attached to the side wall 108. It is disclosed herein that a handle (e.g., the handle 112) is an optional element to a measuring cup in accordance with the present invention.

As depicted in FIG. 1, the indicia 106 denote a volume of the entire measuring cavity 104. For example, when the entire measuring cavity 104 is filled with a material (e.g., flour) to the upper edge 114 of the side wall 108, the indicia 106 denotes the volume of the material contained in the measuring cavity 104. The indicia 106 are provided on the handle 112. Alternatively, the indicia 106 may be provided on the side wall 108 or the bottom wall 110.

FIG. 3 depicts a second embodiment of a measuring cup in accordance with the present invention, which is referred to generally as the measuring cup 200. Structurally, the measuring cup 200 is identical to that of the measuring cup 100 depicted in FIGS. 1 and 2. The measuring cup 200 includes a cup body 202 having a measuring cavity 204 and includes indicia 206. The cup body 202 has a side wall 208 and a bottom wall (not specifically shown). As depicted, a handle 212 is integrally formed with the side wall 208 (e.g., a common piece of material comprises the side wall 108 and the handle 112). In a use position U, the handle 212 provides a means for grasping of the measuring cup 200 for enabling a volume of material to be scooped into the measuring cavity 204. Alternatively, the handle 212 may be formed separately from the side wall 208 and subsequently attached to the side wall 208.

The distinguishing aspect of the measuring cup 200 relative to the measuring cup 100 is the indicia 206. The indicia 206 denote a plurality of different types of volume measurements 215. A dry volume measurement and a liquid volume measurement are examples of the plurality of different types of volume measurements 215. For each one of the different types of volume measurements 215, the indicia 206 denote a plurality of different volumes 216. Various amounts of fluid ounces are examples of the different volumes for liquid volume measurements and various portions of a cup are examples of the different volumes for dry volume measurements.

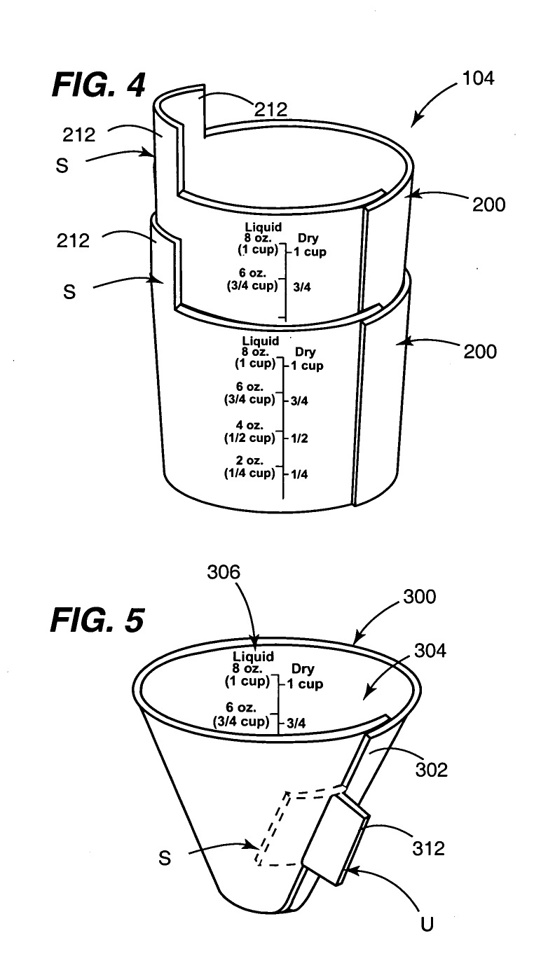

Referring now to FIG. 4, the measuring cup 200 of FIG. 3 in a stacked orientation (i.e., a plurality of the measuring cups 200 in a nested, stacked orientation). To facilitate stacking, the handle 212 of each measuring cup 200 is in a stacking position S. For example, as manufactured and/or packaged for sale, the measuring cups 200 are provided in stacked orientation with the handles 212 in the stacking position S. The handles 212 are configured for being manually movable between the stacking position S and the use position U (FIG. 3), such as by bending the handle 212 from the stacking position S to the use position U. The discussion of stacking of the measuring cup 200 correlates directly to the measuring cup 100 depicted in FIGS. 1 and 2.

FIG. 5 depicts a third embodiment of a measuring cup in accordance with the present invention, which is referred to generally as the measuring cup 300. The measuring cup 300 includes a cup body 302 having a measuring cavity 304 and includes indicia 306. The cup body 302 has a tapered side wall 308 that is formed in a manner such that the measuring cavity 304 has a conical shape.

As depicted in FIG. 5, a handle 312 is integrally formed with the side wall 308 (e.g., a common piece of material comprises the side wall 308 and,the handle 312). The handle 312 is movable between a use position U and a stacking position S for enabling stacking of a plurality of cups having the configuration of the measuring cup 300. In a use position U, the handle 312 provides a means for grasping of the measuring cup 300 for enabling a volume of material to be scooped into the measuring cavity 304. Alternatively, the handle 312 may be formed separately from the side wall 308 and subsequently attached to the side wall 308.

Aside from its physical shape, the distinguishing aspect of the measuring cup 300 relative to the measuring cup 100 of FIGS. 1 and 2 and the measuring cup 200 of FIG. 3 is placement of the indicia 306. The material from which the sidewall 308 is constructed is non-transparent (e.g., a substantially opaque material). Thus, it is not practical and/or desirable for the indicia 306 to be provided on an exterior surface of the sidewall 308 and viewed through the sidewall 308. Accordingly, the 306 indicia 306 are provided within the measuring cavity 304 on an interior surface of the sidewall 308.

Preferably, a cup body of a measuring cup in accordance with the present invention is formed from a biodegradable material. A paper-based material such as Kraft paper and cardboard are examples of biodegradable materials. Alternatively, such cup bodies may be made from plastic sheet, molded plastic or plastic foam.

Preferably, but not necessarily, cup bodies of measuring cups in accordance with the present invention are constructed in a manner enabling them to be manually flattenable (i.e., flattenable with a person's hands). In one embodiment of a manually flattenable construction, the cup body is fabricated in a similar fashion, as is a disposable paper cup. The intent of such a construction is such that, after use, a measuring cup in accordance with the present invention can be flattened prior to or during disposal to save space.

In one embodiment of the present invention, measuring cups in accordance with the present invention are provided in a set. Each one of the measuring cups preferably, but not necessarily, has a measuring cavity of a different volume and indicia denoting a volume of the measuring cavity thereof. Examples of construction and configuration of each one of the measuring cups in a set are depicted by the measuring cups of FIGS. 1-4.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A measuring cup, comprising:
a cup body having a measuring cavity, wherein the cup body is formed from a biodegradable material; and
indicia denoting a volume of at least a portion of the measuring cavity.

2. The measuring cup of claim 1 wherein said indicia is provided within the measuring cavity.

3. The measuring cup of claim 2 wherein the biodegradable material is a substantially non-transparent material.

4. The measuring cup of claim 1 wherein the cup body is manually flattenable such that the cup body can be flattened to save space during disposal.

5. The measuring cup of claim 1 wherein the cup body includes a handle.

6. The measuring cup of claim 4 wherein:
the handle is movable between a use position and a stacking position; and
the cup body is stackable in a nested orientation within an identical other cup body when the handle is in the stacking position.

7. The measuring cup of claim 1 wherein:
said indicia denotes a plurality of different types of volume measurements; and
said indicia denotes a plurality of different volumes for each one of said different types of volume measurements.

8. The measuring cup of claim 1 wherein:
said indicia is provided within the measuring cavity;
the biodegradable material is a substantially non-transparent material;
the cup body is manually flattenable such that the cup body can be flattened to save space during disposal;
the cup body includes a handle;
the handle is movable between a use position and a stacking position;
the cup body is stackable in a nested orientation within an identical other cup body when the handle is in the stacking position;
said indicia denotes a plurality of different types of volume measurements; and
said indicia denotes a plurality of different volumes for each one of said different types of volume measurements.

9. A measuring cup, comprising:
a cup body having a measuring cavity, wherein the cup body is formed from a biodegradable material, wherein the cup body is manually flattenable such that the cup body can be manually flattened to save space during disposal and wherein the biodegradable material is a substantially non-transparent material; and
indicia denoting a volume of at least a portion of the measuring cavity, wherein said indicia is provided within the measuring cavity.

10. The measuring cup of claim 9 wherein the cup body includes a handle.

11. The measuring cup of claim 10 wherein:
the handle is movable between a use position and a stacking position; and
the cup body is stackable in a nested orientation within an identical other cup body when the handle is in the stacking position.

12. The measuring cup of claim 9 wherein:
said indicia denotes a plurality of different types of volume measurements; and
said indicia denotes a plurality of different volumes for each one of said different types of volume measurements.

13. A set of measuring cups, comprising:
a plurality of different volume measuring cups, wherein each one of said measuring cups includes a cup body having a measuring cavity and is formed from a biodegradable material and includes indicia denoting a volume of the measuring cavity thereof.

14. The set of measuring cups of claim 13 wherein said indicia of each one of said measuring cups is provided within the measuring cavity thereof.

15. The set of measuring cups of claim 14 wherein the biodegradable material is a substantially non-transparent material.

16. The set of measuring cups of claim 15 wherein the cup body of each one of said measuring cups is manually flattenable such that the cup body of each one of said measuring cups can be flattened to save space during disposal.

17. The set of measuring cups of claim 13 wherein the cup body of each one of said measuring cups is manually flattenable such that the cup body of each one of said measuring cups can be flattened to save space during disposal.
